(19) United States
(12) Patent Application Publication
(10) Pub. No.: US 2011/0086573 A1
(43) Pub. Date: Apr. 14, 2011

(54) Toy systems with separate accessory pieces engageable by part of a plaything

(75) Inventors: Leonard J. Stubenfoll, Orland Park, IL (US); John K. Fertig, Wheaton, IL (US)

(73) Assignee: Fertig-Stubenfoll Design Group L.L.C.

(21) Appl. No.: 12/924,843

(22) Filed: Oct. 6, 2010

Related U.S. Application Data
(63) Continuation-in-part of application No. 12/006,177, filed on Dec. 31, 2007.

(51) Int. Cl. A63H 3/36; B23P 17/04

(52) U.S. Cl. 446/378; 29/428

(57) ABSTRACT

A toy system with a body part insertable into a self-supported opening in a separate plastic piece self-supportable on a surface. The part frictionally engaging the piece with a protrusion projecting from one of the part or piece. Another part fits into the opening without engaging the piece and telescopes against a spring into the part engaging and picking up the piece upon release of the spring. An audible sound is produced upon inserting the part, releasing the spring, or both. Attaching the piece onto the part is done by placing the piece on a surface, positioning the biased parts over the opening with the lower proximate and pointed toward the opening, pushing down on the upper telescoping it over the lower and inserting the upper into the opening, then releasing the bias to move the two parts apart with the piece picked up by and retained on the upper.

This Application is a continuation-in-part of pending application Ser. No. 12/006,177 filed Dec. 31,2007.

### BACKGROUND OF THE INVENTION

1. Field of the Invention

This invention relates generally to toys, particularly toys which a child may manipulate to change the appearance of the toy.

2. Background Art

Children have long played with toys such as dolls and action figures which the children manipulate to change the toys' appearance. The manipulation required to accessorize prior art toys is often more involved than some children, particularly younger children can or enjoy performing. In addition, there have been toys which are pushed or pulled on, either manually or with a spring bias, to effect a change in the toy.

Zehrung Design Patent D 508,966 issued Aug. 30, 2005 discloses a Pop-Up Pull Toy having a generally cylindrical upper part that fits into a generally cylindrical lower part without any apparent, or suggested, engagement between the sides of the upper and lower parts, or with any other piece. As disclosed, the extension of the upper part out of the lower part, and the retraction of the upper part into the lower part appears to be solely controlled by pushing and pulling on the sinusoidal rod projecting out of the bottom of the lower part, while the lower part is grasped or otherwise restrained. While there may be operating friction between the rod and the bottom of the lower part, there is no apparent, or suggested, engagement between the sides of the upper and lower parts, or with any other piece.

Dashiell U.S. Pat. No. 821,468 issued May 22, 1906 discloses a “jack-in-the-box” type toy having a spring biased figure portion that compresses inside of a hollow cylindrical casing. Rod ends engage slots inside the casing to retain the figure portion inside the casing. When the figure portion is projected from the casing by the spring, a fan carried by the figure is automatically opened.

Muehlstein U.S. Pat. No. 949,544 issued Feb. 15, 1910 discloses another “jack-in-the-box” type toy with a flag carrying artic explorer. A spring is kept compressed in a box by a number of links that pivot with respect to each other, and include a hook at one end that is latched to a staple on the outside of the box.

Goldfarb et al. U.S. Pat. No. 3,526,991 issued Sep. 8, 1970 discloses a pop-up toy which includes a spring on a lower base, and an upper portion that fits over the base. Carried under the upper portion is a suction cup, which also fits over the spring and the base. When the upper portion is pressed down against the spring bias, the suction cup sticks to a flat surface, and temporarily keeps the upper portion from being popped back up by the compressed spring.

Dinhofer U.S. Pat. No. 7,140,945 issued Nov. 28, 2006 discloses a pop-up toy in which a spring is attached to a top and a base, with extending arms just below the top to the spring. The base is weighted to keep it from bouncing away from the surface it is standing on when the spring is released.

Boles U.S. Pat. No. 2,955,382 issued Oct. 11, 1960 discloses a toy attachment for a baby feeding bottle in which a stitched loop of material that slides over the bottle is provided with cross brace members to position the loop adjacent the bottom of the bottle. The loop also has snap eyelets that engage snap fasters on a toy figure to attach the toy figure to the bottle.

Fels U.S. Pat. No. 3,581,434 issued Jun. 1, 1971 discloses a two component rocket-simulative toy in which a spring attached to a base launches a projectile that is pushed down on the base compressing the spring. A flange around the base momentarily engages the projectile until the spring overcomes the resistance and launches the projectile.

Rehkemper et al. U.S. Pat. No. 6,648,721 issued Nov. 18, 2003 discloses a generally tubular shaped doll with accessories generally made of stretch fabric that can be pulled onto various parts of the doll.

Gonzalez U.S. Pat. No. 6,790,117 issued Sep. 14, 2004 discloses a flat doll shape with flat clothing shapes that are attached magnetically.

There remains a need, however, for toy systems that provide a unique way to young children, such as two (2) year olds, to accessorize and transform playthings by simply pushing the plaything into a separate piece supported on a surface, with “clothing” or accessories painted, sculpted, or otherwise put on the outer surface of the separate piece.

### SUMMARY OF THE INVENTION

The present invention is concerned with providing toy systems having a body including at least a first substantially rigid part with at least one end, a plastic piece separate from the body self-supportable on a surface, the separate piece substantially defining a self-supported opening, the at least one end of the part being insertable into the opening when the part is placed atop the piece, the part frictionally engaging the separate piece to retain the separate piece on the body, with a protrusion projecting from one of the part or separate piece toward the other of the separate piece or part to frictionally engage the part and the separate piece.

The other one of the part or separate piece from which the protrusion projects may have a recess that receives the protrusion. The separate piece may be a complete band substantially defining the opening. There may be a plurality of a protrusions projecting from one of the part or separate piece toward the other of the separated piece or part to frictionally engage the part and the separate piece, and the other one of the part or separate piece from which the protrusion projects may have a plurality of recesses.

The geometric shapes of the part and the opening in the separate piece may be substantially the same, such as circular in cross-section. The at least one end of the part insertable into the opening substantially defined by the separate piece or the opening substantially defined by the separate piece may be chamfered to facilitate insertion of the at least one end of the part into the opening substantially defined by the separate piece.

The toy system may have a body including at least a first part with at least one end and an interior space, a second part that is at least partially in the interior space, a spring biasing the first part and the second part away from each other, a plastic piece separate from the body self-supportable on a surface, the separate piece substantially defining a self-supported opening, the second part not at least partially in the interior space being insertable into the self-supported opening substantially defined by the separate piece without engaging the separate piece, the first part being telescopically moveable against the spring biasing with the at least one end of the part being insertable into the self-supported opening to frictionally engage the separate piece, a protrusion projecting from one of the first part or the separate piece toward the other of the separated piece or first part to frictionally engage the first part and the separate piece, an the separate piece being picked up and retained by the first part when the spring biasing moves the first part away from the second part.

The first part or the separate piece from which the protrusion projects may have a recess that receives the protrusion. The first part may have a plurality of protrusions projecting generally outwardly from the part with the separate piece having an inward recess in the opening of the separate piece.

The toy system of may produce an audible sound upon insertion of the at least one end of the part into the self-supported opening against the spring biasing, when the spring biasing moves the first part away from the second part, or both.

The present invention also provides a method of attaching a piece having an opening onto an upper one of two generally elongated parts that telescope axially against a bias in a toy system by placing the piece having the opening on a surface with the opening directed upwardly, positioning the biased apart parts over the opening in the piece with the lower one of the two parts proximate and pointed toward the opening and the upper one of the two parts away from the opening, pushing down on the upper one of the parts telescoping it against the bias over the lower one of the two parts and inserting the upper one of the two parts into the opening; and releasing the parts allowing the bias to move the two parts apart with the piece picked up by and retained on the upper one of the two parts.

The method of putting a piece on a part in a toy system may also produce an audible sound upon pushing down on the upper one of the two parts into the opening against the bias, upon releasing the parts allowing the bias to move the two parts apart with the piece retained on the upper one of the two parts, or both.

### BRIEF DESCRIPTION OF THE DRAWINGS

For a better understanding of the present invention, reference may be had to the accompanying drawings in which:

FIG. 1 is a schematic front elevation view of components of an embodiment of the present invention;

FIG. 2 is a schematic top plan view of the components of the embodiment shown in FIG. 1;

FIG. 3 is a schematic front elevation view of the components of the embodiment shown in FIG. 1 put together;

FIG. 4 is a schematic top plan view of the components of the embodiment shown in FIG. 1 put together;

FIG. 5 is an enlarged, fragmentary view, partially in section taken generally vertically through the center of one of the components of the embodiment shown in FIG. 1;

FIG. 6 is a schematic front elevation view of components of another embodiment of the present invention;

FIG. 7 is a schematic top plan view of the components of the embodiment shown in FIG. 6;

FIG. 8 is a schematic front elevation view of the components of the embodiment shown in FIG. 6 put together in a sequence of two steps;

FIG. 9 is a schematic top plan view of the components of the embodiment shown in FIG. 6 put together in the same sequence of two steps as in FIG. 8;

FIG. 10 is a schematic top plan view of components of yet another embodiment of the present invention;

FIG. 11 is a schematic sectional view of one of the components taken generally along line 11-11 of FIG. 10 and a schematic front elevation view of the other component of the embodiment shown in FIG. 10;

FIG. 12 is an enlarged sectional view of one of the components taken generally along line 12-12 of FIG. 11;

FIG. 13 is a schematic front elevation view of the components of the embodiment shown in FIGS. 10 and 11 put together in a sequence of three steps;

FIG. 14 is a schematic top plan view of the components of the same three step sequence as in FIG. 13;

FIG. 15 is a schematic vertical sectional view of components of still another embodiment of the present invention;

FIG. 16 is a schematic vertical sectional view of an additional component of the embodiment of the present invention shown in FIG. 15;

FIG. 17 is a schematic top plan view of each of the separated components of the embodiment shown in FIG. 15;

FIG. 18 is a schematic horizontal sectional view of the component shown in FIG. 16;

FIG. 19 is a schematic vertical sectional view of the components of the embodiment shown in FIGS. 15 and 16 put together in a sequence of three steps;

FIG. 20 is a schematic top plan view of a component of a further embodiment of the present invention that combines with the components of the embodiment shown in FIG. 15;

FIG. 21 is a schematic top plan view of the component shown in FIG. 20; FIG. 22 is a schematic vertical sectional view of components of still another further embodiment of the present invention;

FIG. 23 is a schematic vertical sectional view of an additional component of the embodiment of the present invention shown in FIG. 22;

FIG. 24 is a schematic top plan view of each of the separated components of the embodiment shown in FIG. 22;

FIG. 25 is a schematic top plan view of the component shown in FIG. 23; and

FIG. 26 is a schematic vertical sectional view of the components of the embodiment shown in FIGS. 22 and 23 put together in a sequence of three steps.

### DETAILED DESCRIPTION

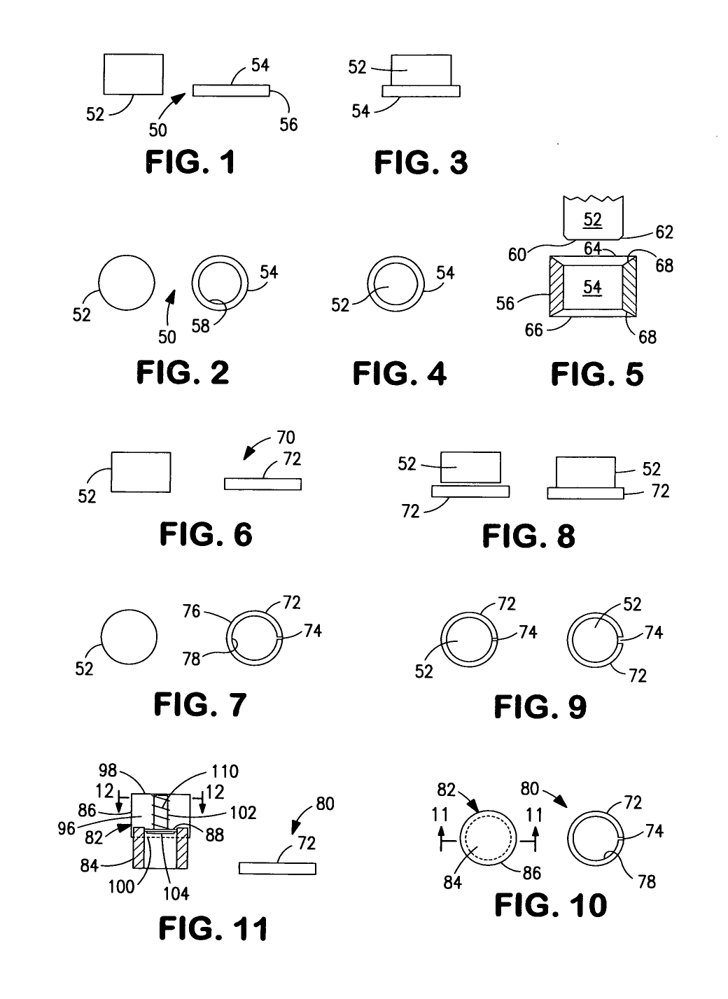

Referring now to the drawings, in which like elements are identified by like reference numerals, there is schematically shown in FIGS. 1-4 a toy system 50 comprising the most basic embodiment of the present invention. More particularly, toy system 50 includes a body component 52 and a separate piece providing an accessory component 54. Body 52 as illustrated in FIGS. 1-4 is of a generally cylindrical shape and has a predetermined outer dimension or diameter, as for example 1.500 inches; it may be made of a material that is somewhat rigid, such as polystyrene (PS), acrylonitrile butadiene styrene (ABS), or polycarbonate (PC). Accessory 54, is a band generally in the shape of a ring having an outer surface 56 and defining an opening 58 having an initial, pre-selected, inner diameter, as for example 1.450 inches, that is slightly less than, the predetermined outer diameter of body 52. The accessory is made of a flexible, elastic material, such as a partially reticulated polyether type polyurethane foam, so that opening 58 will sufficiently expand upon insertion of body 52 and then contract to be retained about body 52 as is illustrated in FIGS. 3 and 4.

To facilitate insertion of body 52 into accessory 54, the free, lower as illustrated in FIGS. 1-5, end 60 of body 52 is provided with a slight taper or chamfer 62 as is shown in FIG. 5. In addition, or as an alternative to chamfer 62 on end 60 of the body, one end 64 of accessory 54, or both ends 64 and 66 as illustrated in FIG. 5, may be provided with a slight taper or chamfer 68 to facilitate insertion of body 52.

As illustrated in FIGS. 3 and 4, toy system 50 is put together by a child placing body 52 atop accessory 54 and then pushing down as illustrated by the arrow in FIG. 3 to attach accessory 54 to body 52. Although only schematically shown in FIGS. 1-5, it will be apparent to those skilled in the art, and particularly from variations of the present invention shown in FIGS. 25-26 and 27-34 that both the designs of the body component and one or more of the accessory component, particularly the outer surface, may be molded, sculpted or otherwise embellished to provide various characters or other playthings which are thematically related and which attachment and removal of the one or more accessory components enhance and provide play.

FIGS. 6-9 illustrate another toy system 70 of the present invention in which body component 52 is the same as that previously shown and described with respect to toy system 50. However, in toy system 70, accessory component 72, is a band or ring with a slit, separation, or break 74. Accessory component 72 also provides an outer surface 76, and still substantially defines an opening 78. Before accessory 72 is put on a body, substantially defined opening 78 has an initial, pre-selected inner diameter, for example 1.440 inches in the case of a band with a 0.125 inch wall thickness, that is slightly less than the predetermined 1.500 inch outer diameter of body 52. As the wall thickness of the accessory band or ring of the same material increases, the difference between the outer diameter of the body and the inner diameter of the opening may decrease because of the greater compression strength of the thicker band. Chamfers such as 62 and/or 68 may again be provided to facilitate insertion of body 52 into accessory 72.

Toy system 70 is put together by a child placing body 52 atop accessory 72 and then pushing down as illustrated by the arrow in FIG. 8 to attach accessory 72 to body 52. Opening 78 will effectively expand upon insertion of body 52, at least in part by spreading apart band 72, more particularly separation 74, as illustrated in FIGS. 8 and 9, and then contract to be retained about body 52. While it is still desirable to make accessory 72 out of a flexible, elastic material system 70 does not rely on the resiliency of the material itself to the extent that system 50 does, and hence there may be a larger number of acceptable materials, such as acrylonitrile butadiene styrene (ABS), vinyl, or nylon.

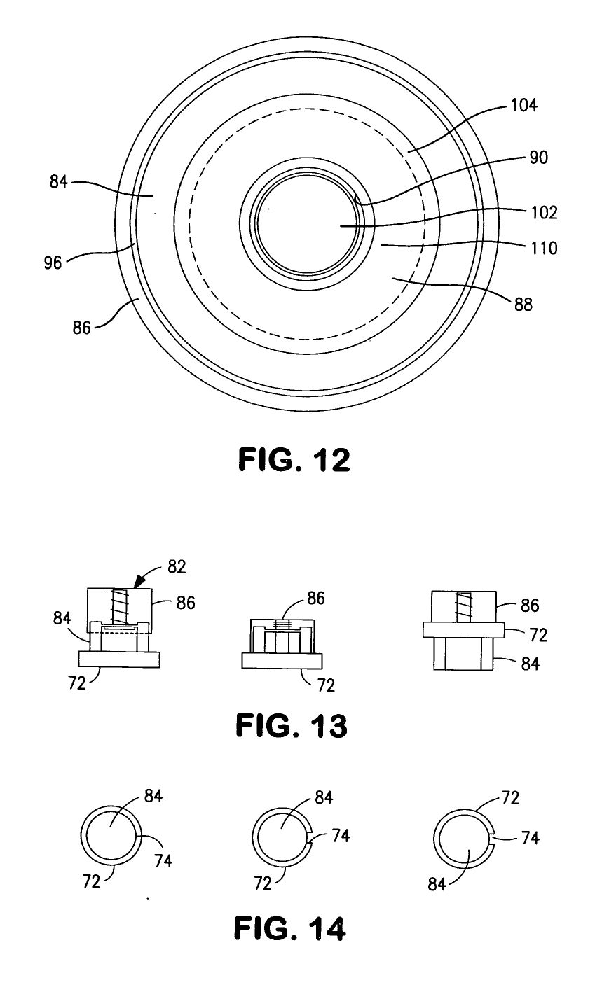

Toy system 80, which is illustrated in FIGS. 10-13, has the same accessory component 72 as toy system 70. However, body 82 comprises a lower part 84 and an upper part 86, which are telescopically related to each other. Lower part 84 is of a generally tubular shape that is circular in cross-section. There is an upper inner shoulder 88 that has a generally central aperture 90. Lower part 84 has an outer dimension or diameter, as for example 1.250 inches, that is significantly less than opening 78 of accessory 72 such that lower part 84 easily slips in and out of opening 78 of accessory 72 without any retention or attachment of accessory 72 by lower part 84.

Upper part 86 is also of a generally tubular shape that is circular in cross-section with an interior space 96, a closed top 98, and an open bottom 100. Depending from closed top 98 is a post 102 with an enlarged bottom cap or head 104. Post 102 is generally cylindrical and, except for cap 104, has an outer diameter that readily fits in aperture 90 and allows for reciprocal movement of post 102 with aperture 90. Cap 104 is sufficiently larger than aperture 90 so as not to be able to pass through aperture 90. Part 86 has an inner diameter sufficiently large to permit telescopic movement of lower part 84 into and out of upper part 86. Around post 102, between the underside of closed top 98 and the upper side of shoulder 88, is a coil spring 110 to bias parts 84 and 86 apart. As is perhaps best shown in FIG. 11, cap 104 is on the underside of shoulder 88 to keep assembled parts 84 and 86 from coming apart. Again, tapers or chamfers such as 62 and/or 68 may again be provided to facilitate insertion of upper part of body 82 into accessory 72.

The outer dimension or diameter of upper part 86 is slightly larger than opening 78 of accessory 72. As illustrated in FIGS. 13 and 14, toy system 80 is put together by a child placing body 82 with lower part 84 atop accessory 72 and then pushing down as illustrated by the arrow in the middle sequence step of FIG. 13 to attach accessory 72 to body 82, or more particularly to upper part 86. When body 82 is released by the child, the bias of spring 110 will return upper part 86, with accessory 72 attached, upwardly as illustrated by the arrow in the leftmost sequence step of FIG. 13.

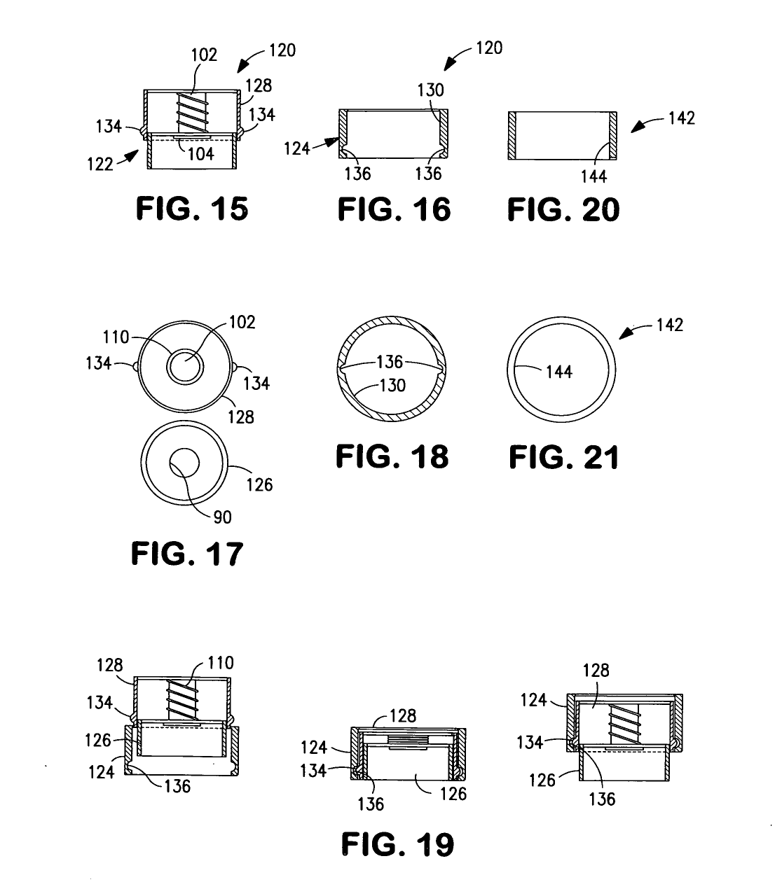

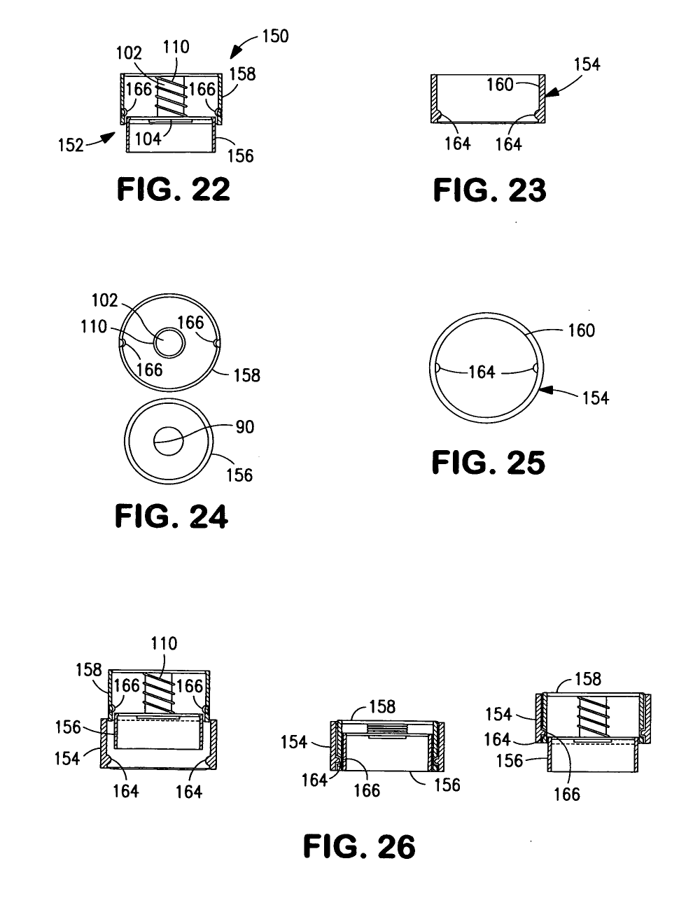

FIGS. 15-26 illustrate embodiments of the present invention in which the engagement between the body component and accessory component is enhanced by at least one protuberance on one of the components. Schematically shown in FIGS. 15-19 is a toy system 120 that includes a body component 122 and an accessory component 124. Body 122 comprises a lower part 126 and an upper part 128. As with lower part 84 and accessory 72 of toy system 80 illustrated in FIGS. 11-14, the materials, configurations and relative dimensions of lower part 126 and accessory 124 are such that lower part 126 easily slips in and out of opening 130 of accessory 124 without any retention or attachment of accessory 124 by lower part 126. Separate accessory piece is self-supportable on a surface such as the ground, a table, a floor, a chair, a bed, or the like.

Again as with toy system 80 illustrated in FIGS. 11-14, lower part 126 and upper part 128 are generally elongated and similar to lower part 84 upper part 86, respectively, in structure to permit generally axial telescopic movement of lower part 126 into and out of upper part 128. They are also similar with respect to lower part 126 having aperture 90 and upper part 128 having depending post 102 with enlarged bottom cap or head 104 and coil spring 110 to bias parts 126 and 128 apart as in toy system 80. Also tapers or chamfers such as 62 and/or 68 may again be provided to facilitate insertion of upper part 128 of body 122 into accessory 124. However, toy system 120 differs in having a pair of generally diametrically opposed radially outward protuberances 134 on the outer wall of upper part 128, adjacent the lower edge of upper body part 128 to facilitate frictional engagement with, and retention of, accessory component 124. As illustrated in FIGS. 16 and 18, accessory 124 is provided with cooperating recesses 136 that receive protuberances 134. More or less than the illustrated number of protuberances and recesses may be provided.

As illustrated in FIG. 19, toy system 120 is easily put together by a child placing body 122 over an accessory component 124 resting on any generally flat support with opening 130 directed upwardly. Body 122 is positioned with lower body part 126 proximate and pointed at opening 130 of accessory 124, and then pushing down on upper part 128 to telescope lower part 126 into upper part 128 against the bias of spring 110 to insert upper part 128 into opening 130 to attach accessory 124 to body 122, or more particularly to upper part 128. When body 122 is released by the child, the bias of spring 110 will return upper part 128, with accessory 124 attached, upwardly as illustrated in the leftmost sequence step of FIG. 19. The sequence of pushing down and releasing body 122 produces an audible click sound to signal and further enhance the task completion for the child.

A variation of toy system 120 is illustrated in FIGS. 20 and 21 where an accessory component 142 that is made of a more flexible material than acrylonitrile butadiene styrene (ABS), such as perhaps a partially reticulated polyether type polyurethane foam does not have any recesses in its opening 144. Even though accessory component is of a more flexible material it is still self-supported on a surface, and opening 144 is also still self-supported.

FIGS. 22-26 illustrate another embodiment similar to toy system 120. In the toy system 150 illustrated in FIGS. 22-26, the components are similar in structure and operation to those illustrated in, and described with respect to, FIGS. 15-19 except as to where the protuberance and recesses are. More particularly, toy system 150 that includes a body component 152 and an accessory component 154. Body 152 comprises a lower part 156 and an upper part 158, and lower part 156 easily slips in and out of opening 160 of accessory 154 without any retention or attachment of accessory 154 by lower part 156.

Again, there is restrained telescopic movement of lower part 156 into and out of upper part 158 about post 102 with enlarged bottom cap or head 104, and they are biased apart by coil spring 110. Also tapers or chamfers such as 62 and/or 68 may again be provided to facilitate insertion of upper part 158 of body 152 into accessory 154. However, toy system 150 differs in having a pair of generally diametrically opposed inward protuberances 164 on the inner wall defining opening 160 in accessory 154, and cooperating recesses 166 in the upper part 158 of body component 152.

As illustrated in FIG. 26, toy system 150 is again easily put together by a child placing body 152 over an accessory component 154 resting on any generally flat support, with lower part 156 positioned atop accessory 154, and then pushing down to attach accessory 154 to upper part 158 of body 152. Upon release of body 152, the bias of spring 110 will return upper part 128, with accessory 124 attached, upwardly as illustrated in the leftmost sequence step of FIG. 26.

Although only schematically shown in the drawings, it will be apparent to those skilled in the art, particularly from variations shown in FIGS. 25, 26 and 27-34 of co-pending application Ser. No. 12/006,177, that both the designs of the body component and one or more of the accessory component may be embellished to provide various characters or other playthings which are thematically related and which attachment and removal of the one or more accessory components, not only dress but even transform the toy to provide and enhance play.

While particular embodiments of the invention have been shown and described with some variations and alternatives, further variations and modifications will occur to those skilled in the art. It is intended in the appended claims to cover all such variations and modifications that come within the true spirit and scope of the present invention.

What is claimed as new and desired to be secured by letters patent is:

1. A toy system comprising:
a body including at least a first substantially rigid part with at least one end;
a plastic piece separate from the body self-supportable on a surface;
the separate piece substantially defining a self-supported opening;
the at least one end of the part being insertable into the opening when the part is placed atop the piece;
the part frictionally engaging the separate piece to retain the separate piece on the body; and
a protrusion projecting from one of the part or separate piece toward the other of the separate piece or part to frictionally engage the part and the separate piece.

2. The toy system of claim 1 in which the other one of the part or separate piece from which the protrusion projects has a recess that receives the protrusion.

3. The toy system of claim 1 in which the protrusion projects generally outwardly from the part and the separate piece has an inward recess in the opening of the separate piece.

4. The toy system of claim 1 in which the protrusion projects generally inwardly into the opening of the separate piece and the outside of the part has a recess.

5. The toy system of claim 1 in which the separate piece is a complete band substantially defining the opening.

6. The toy system of claim 1 in which there are a plurality of a protrusions projecting from one of the part or separate piece toward the other of the separated piece or part to frictionally engage the part and the separate piece.

7. The toy system of claim 6 in which the other one of the part or separate piece from which the protrusion projects has a plurality of recesses.

8. The toy system of claim 1 in which:
the part has a geometric shape; and
the opening substantially defined by the separate piece has substantially the same geometric shape as the geometric shape of the part.

9. The toy system of claim 8 in which the geometric shape of the part and the geometric shape of the opening defined by the separate piece are circular in cross-section.

10. The toy system of claim 1 in which at least one of the at least one end of the part insertable into the opening substantially defined by the separate piece, or the opening substantially defined by the separate piece, is chamfered to facilitate insertion of the at least one end of the part into the opening substantially defined by the separate piece.

11. A toy system comprising:
a body including at least a first part with at least one end and an interior space;
a second part that is at least partially in the interior space;
a spring biasing the first part and the second part away from each other;
a plastic piece separate from the body self-supportable on a surface;
the separate piece substantially defining a self-supported opening;
the second part not at least partially in the interior space being insertable into the self-supported opening substantially defined by the separate piece without engaging the separate piece;
the first part being telescopically moveable against the spring biasing with the at least one end of the part being insertable into the self-supported opening to frictionally engage the separate piece;
a protrusion projecting from one of the first part or the separate piece toward the other of the separated piece or first part to frictionally engage the first part and the separate piece; and
the separate piece being picked up and retained by the first part when the spring biasing moves the first part away from the second part.

12. The toy system of claim 11 in which the other one of the first part or the separate piece from which the protrusion projects has a recess that receives the protrusion.

13. The toy system of claim 11 in which the first part has a plurality of protrusions projecting generally outwardly from the part and the separate piece has an inward recess in the opening of the separate piece.

14. The toy system of claim 11 in which an audible sound is produced upon insertion of the at least one end of the part into the self-supported opening against the spring biasing.

15. The toy system of claim 11 in which an audible sound is produced when the spring biasing moves the first part away from the second part.

16. The toy system of claim 11 in which an audible sound is produced both upon insertion of the at least one end of the part being into the self-supported opening against the spring biasing and when the spring biasing moves the first part away from the second part.

17. A method of attaching a piece having an opening onto an upper one of two generally elongated parts that telescope axially against a bias in a toy system, comprising the steps of:
placing the piece having the opening on a surface with the opening directed upwardly;
positioning the biased apart parts over the opening in the piece with the lower one of the two parts proximate and pointed toward the opening and the upper one of the two parts away from the opening;
pushing down on the upper one of the parts telescoping it against the bias over the lower one of the two parts and inserting the upper one of the two parts into the opening; and
releasing the parts allowing the bias to move the two parts apart with the piece picked up by and retained on the upper one of the two parts.

18. The method of putting a piece on a part in a toy system of claim 17 further comprising the step of producing an audible sound upon pushing down on the upper one of the two parts into the opening against the bias.

19. The method of putting a piece on a part in a toy system of claim 17 further comprising the step of producing an audible sound upon releasing the parts allowing the bias to move the two parts apart with the piece retained on the upper one of the two parts.

20. The method of putting a piece on a part in a toy system of claim 17 further comprising the step of producing an audible sound both upon pushing down on the upper one of the two parts into the opening against the bias and upon releasing the parts allowing the bias to move the two parts apart with the piece retained on the upper one of the two parts.
